(19) United States
(12) Patent Application Publication
(10) Pub. No.: US 2023/0402668 A1
(43) Pub. Date: Dec. 14, 2023

(54) SYSTEMS AND METHODS FOR ESTIMATING BATTERY TEMPERATURE

(71) Applicant: Apple Inc., Cupertino, CA (US)

(72) Inventors: Wei He, San Jose, CA (US); Guangyu Liu, San Jose, CA (US); Tai Sik Hwang, San Jose, CA (US)

(21) Appl. No.: 17/837,964

(22) Filed: Jun. 10, 2022

(51) Int. Cl. H01M 10/48

(52) U.S. Cl. CPC H01M 10/486; G01K 2217/00

(57) ABSTRACT

A battery includes a battery cell and processing circuitry. The processing circuitry is configured to determine an estimated temperature of the battery cell as a function of various models. The models include a battery cell heat generation model that receives a first input indicative of a battery voltage measurement, a second input indicative of a voltage corresponding to a battery open-circuit voltage (OCV) model, and a third input indicative of a battery current measurement. The models also include a gas gauge and system heat generation model that receives the third input. The models also include a battery and gas gauge heat transfer model that receives a fourth input indicative of a gas gauge temperature measurement.

### BACKGROUND

The present disclosure relates generally to systems and methods for estimating battery temperature. More specifically, the present disclosure relates to estimating a battery cell temperature based on a gas gauge temperature measurement and various other inputs and models.

In traditional systems, a battery may include at least one battery cell formed by electrodes, a separator, electrolyte, and various other parts disposed in a housing, terminals protruding from the housing, and other possible componentry. The battery may be employed as a source of power for an electric device (e.g., electronic device). A secondary (e.g., rechargeable) battery, such as a lithium-ion battery, may be discharged and recharged a number of times over a lifespan of the battery to provide the power to the electric device. During discharge and/or recharging, the battery cell may produce heat that can affect characteristics (e.g., performance, lifespan, or structure) of the battery and/or the electric device. Accordingly, determining a battery cell temperature and/or adjusting aspects of the battery or electric device based on the battery cell temperature may be helpful in preserving desired characteristics of the battery and/or the electric device.

Certain traditional systems may employ a battery cell temperature sensor that detects the battery cell temperature, but battery cell temperature sensors can be expensive. Further, battery cell temperatures contribute to an increase in a volume of the battery and a corresponding decrease in an energy density of the battery. Additionally or alternatively, battery cell temperature may be inferred based on various characteristics, but traditional systems and methods that infer battery cell temperature are inaccurate, costly, and/or error prone. Accordingly, it is now recognized that improved systems and methods for determining or estimating a temperature of a battery cell are desired.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a battery includes a battery cell and processing circuitry. The processing circuitry is configured to determine an estimated temperature of the battery cell as a function of various models. The models include a battery cell heat generation model that receives a first input indicative of a battery voltage measurement, a second input indicative of a voltage corresponding to a battery open-circuit voltage (OCV) model, and a third input indicative of a battery current measurement. The models also include a gas gauge and system heat generation model that receives the third input. The models also include a battery and gas gauge heat transfer model that receives a fourth input indicative of a gas gauge temperature measurement.

In another embodiment, one or more tangible, non-transitory, computer-readable media store instructions thereon that, when executed by one or more processors, are configured to cause the one or more processors to perform various functions. The functions include executing a battery cell heat generation model that receives a first input indicative of a battery voltage measurement of a battery, a second input indicative of a voltage corresponding to a battery open-circuit voltage (OCV) model of the battery, and a third input indicative of a battery current measurement of the battery. The functions also include executing a gas gauge and system heat generation model that receives the third input. The functions also include executing a battery and gas gauge heat transfer model that receives a fourth input indicative of a gas gauge temperature measurement of the battery. The functions also include determining, based on a first output of the battery cell heat generation model, a second output of the gas gauge and system heat generation model, and a third output of the battery and gas gauge heat transfer model, an estimated temperature of a battery cell of the battery.

In yet another embodiment, a method includes determining a battery voltage measurement, determining a battery current measurement, determining a gas gauge temperature measurement, and determining a voltage corresponding to a battery open-circuit voltage (OCV) model. The method also includes determining, via processing circuitry, an estimated temperature of a battery cell based on a plurality of models, the battery voltage measurement, the battery current measurement, the gas gauge temperature measurement, and the voltage corresponding to the battery OCV model.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a block diagram of an electronic device, according to embodiments of the present disclosure;

FIG. 2 is a block diagram of a battery employed in the electronic device of FIG. 1, according to embodiments of the present disclosure;

FIG. 3 is a flow diagram illustrating an algorithm for estimating a temperature of a battery cell of the battery of FIG. 2, according to embodiments of the present disclosure;

FIG. 4 is schematic diagram of a process for developing the algorithm of FIG. 3, according to embodiments of the present disclosure;

FIG. 5 is a graph illustrating a gas gauge temperature, an estimated battery cell temperature (e.g., determined via the algorithm of FIG. 3), and an actual battery cell temperature over time, according to embodiments of the present disclosure;

FIG. 6 is a graph illustrating a gas gauge temperature error and an estimated battery cell temperature error over time, according to embodiments of the present disclosure;

FIG. 7 is a graph illustrating a gas gauge power over time, according to embodiments of the present disclosure; and

FIG. 8 is a process flow diagram illustrating a method of estimating a battery cell temperature based on various inputs and various models, according to embodiments of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1% of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on).

The present disclosure relates generally to systems and methods for estimating battery cell temperature based on a gas gauge temperature measurement and various other inputs and models. For example, a battery may include a battery cell formed by electrodes, a separator, electrolyte and various other parts disposed in a housing, terminals protruding from the housing, and a battery management system including processing circuitry and memory circuitry. The memory circuitry includes instructions stored thereon that, when executed by the processing circuitry, causes the processing circuitry to perform various functions, such as determining an estimated temperature of the battery cell.

In accordance with present embodiments, the processing circuitry receives various inputs, enters the inputs to various models, and determines the estimated battery cell temperature based on the various inputs and models. For example, a battery cell heat generation model executed by the processing circuitry of the battery management system may receive, as inputs, data indicative of a voltage corresponding to a battery open-circuit voltage (OCV) model, a battery voltage measurement (e.g., measured at a first time step), a battery current measurement (e.g., measured at the first time step), a first coefficient of heat generation due to cell impedance, and a second coefficient of heat generation due to entropy. Further, a gas gauge and system heat generation model executed by the processing circuitry of the battery management system may receive, as inputs, data indicative of the battery current measurement (e.g., measured at the first time step), a third coefficient (e.g., linear coefficient) of gas gauge and system heat generation due to current, and a fourth coefficient (e.g., non-linear coefficient) of gas gauge and system heat generation due to current. Further still, a battery and gas gauge heat transfer model executed by the processing circuitry of the battery management system may receive, as inputs, data indicative of the gas gauge temperature measurement (e.g., measured at the first time step), a fifth coefficient of heat transfer between the battery cell and a gas gauge, and a sixth coefficient of temperature change due to heat capacity.

The battery cell heat generation model, the gas gauge and system heat generation model, and the battery and gas gauge heat transfer model described above may be executed in parallel, each producing a corresponding output. That is, the battery cell heat generation model may produce a first output (e.g., battery cell heat generation model output), the gas gauge and system heat generation model may produce a second output (e.g., gas gauge and system heat generation model output), and the battery and gas gauge heat transfer model may produce a third output (e.g., battery and gas gauge heat transfer model output). A thermal input determination logic may then be executed by the processing circuitry of the battery management system and receive, as inputs, data indicative of the first output, the second output, the third output, and the aforementioned gas gauge temperature measurement (e.g., measured at the first time step), second coefficient, and fifth coefficient. Accordingly, the thermal input determination logic may produce a fourth output (e.g., thermal input determination logic output) that is a function of the first output, the second output, the third output, the gas gauge temperature measurement (e.g., measured at the first time step), the second coefficient, and the fifth coefficient.

A battery temperature update logic may then be executed by the processing circuitry of the battery management system, and outputs the estimated temperature of the battery cell. For example, the battery temperature logic update may receive, as inputs, data indicative of the fourth output and a previously determined estimated battery cell temperature in an earlier time step (e.g., a time step immediately preceding the first time step). In this way, the algorithm for determining the estimated battery cell temperature may be executed by the processing circuitry of the battery management system periodically at various time steps. For example, the estimated battery cell temperature determined at the first time step as described above is employed in determining the estimated battery cell temperature at a second time step following the first time step.

It should be noted that the above-described algorithm executed, for example, by the processing circuitry of the battery management system is merely exemplary, and that additional or alternate processing steps are also possible. In general, the battery management system may employ various inputs (e.g., the voltage corresponding to the battery OCV model, the battery voltage measurement, the battery current measurement, the gas gauge temperature measurement, various coefficients, and an estimated temperature of the battery cell determined at a previous time step) to determine the estimated temperature of the battery cell. Presently disclosed systems and methods for determining the estimated battery cell temperature may, in general, reduce a cost associated with determining battery cell temperature, reduce a volume of the battery, improve an energy density of the battery, or any combination thereof relative to traditional embodiments. These and other features will be described in detail below with reference to the drawings.

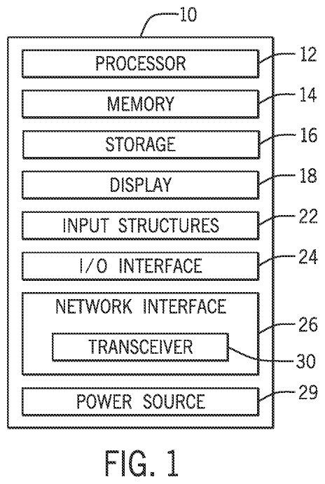

FIG. 1 is a block diagram of an electronic device 10, according to embodiments of the present disclosure. The electronic device 10 may include, among other things, one or more processors 12 (collectively referred to herein as a single processor for convenience, which may be implemented in any suitable form of processing circuitry), memory 14, nonvolatile storage 16, a display 18, input structures 22, an input/output (I/O) interface 24, a network interface 26, and a power source 29. The various functional blocks shown in FIG. 1 may include hardware elements (including circuitry), software elements (including machine-executable instructions) or a combination of both hardware and software elements (which may be referred to as logic). The processor 12, memory 14, the nonvolatile storage 16, the display 18, the input structures 22, the input/output (I/O) interface 24, the network interface 26, and/or the power source 29 may each be communicatively coupled directly or indirectly (e.g., through or via another component, a communication bus, a network) to one another to transmit and/or receive data between one another. It should be noted that FIG. 1 is merely one example of a particular implementation and is intended to illustrate the types of components that may be present in the electronic device 10.

By way of example, the electronic device 10 may include any suitable computing device, including a desktop or notebook computer (e.g., in the form of a MacBook®, MacBook® Pro, MacBook Air®, iMac®, Mac® mini, or Mac Pro® available from Apple Inc. of Cupertino, California), a portable electronic or handheld electronic device such as a wireless electronic device or smartphone (e.g., in the form of a model of an iPhone® available from Apple Inc. of Cupertino, California), a tablet (e.g., in the form of a model of an iPad® available from Apple Inc. of Cupertino, California), a wearable electronic device (e.g., in the form of an Apple Watch® by Apple Inc. of Cupertino, California), and other similar devices. It should be noted that the processor 12 and other related items in FIG. 1 may be embodied wholly or in part as software, hardware, or both. Furthermore, the processor 12 and other related items in FIG. 1 may be a single contained processing module or may be incorporated wholly or partially within any of the other elements within the electronic device 10. The processor 12 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The processors 12 may include one or more application processors, one or more baseband processors, or both, and perform the various functions described herein.

In the electronic device 10 of FIG. 1, the processor 12 may be operably coupled with a memory 14 and a nonvolatile storage 16 to perform various algorithms. Such programs or instructions executed by the processor 12 may be stored in any suitable article of manufacture that includes one or more tangible, computer-readable media. The tangible, computer-readable media may include the memory 14 and/or the nonvolatile storage 16, individually or collectively, to store the instructions or routines. The memory 14 and the nonvolatile storage 16 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor 12 to enable the electronic device 10 to provide various functionalities.

In certain embodiments, the display 18 may facilitate users to view images generated on the electronic device 10. In some embodiments, the display 18 may include a touch screen, which may facilitate user interaction with a user interface of the electronic device 10. Furthermore, it should be appreciated that, in some embodiments, the display 18 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input structures 22 of the electronic device 10 may enable a user to interact with the electronic device 10 (e.g., pressing a button to increase or decrease a volume level). The I/O interface 24 may enable electronic device 10 to interface with various other electronic devices, as may the network interface 26. In some embodiments, the I/O interface 24 may include an I/O port for a hardwired connection for charging and/or content manipulation using a standard connector and protocol, such as the Lightning connector provided by Apple Inc. of Cupertino, California, a universal serial bus (USB), or other similar connector and protocol. The network interface 26 may include, for example, one or more interfaces for a personal area network (PAN), such as an ultra-wideband (UWB) or a BLUETOOTH® network, a local area network (LAN) or wireless local area network (WLAN), such as a network employing one of the IEEE 802.11x family of protocols (e.g., WI-FI®), and/or a wide area network (WAN), such as any standards related to the Third Generation Partnership Project (3GPP), including, for example, a 3rd generation (3G) cellular network, universal mobile telecommunication system (UMTS), 4th generation (4G) cellular network, long term evolution (LTE®) cellular network, long term evolution license assisted access (LTE-LAA) cellular network, 5th generation (5G) cellular network, and/or New Radio (NR) cellular network, a 6th generation (6G) or greater than 6G cellular network, a satellite network, a non-terrestrial network, and so on. In particular, the network interface 26 may include, for example, one or more interfaces for using a cellular communication standard of the 5G specifications that include the millimeter wave (mmWave) frequency range (e.g., 24.25-300 gigahertz (GHz)) that defines and/or enables frequency ranges used for wireless communication. The network interface 26 of the electronic device 10 may allow communication over the aforementioned networks (e.g., 5G, Wi-Fi, LTE-LAA, and so forth).

The network interface 26 may also include one or more interfaces for, for example, broadband fixed wireless access networks (e.g., WIMAX®), mobile broadband Wireless networks (mobile WIMAX®), asynchronous digital subscriber lines (e.g., ADSL, VDSL), digital video broadcasting-terrestrial (DVB-T®) network and its extension DVB Handheld (DVB-H®) network, ultra-wideband (UWB) network, alternating current (AC) power lines, and so forth.

As illustrated, the network interface 26 may include a transceiver 30. In some embodiments, all or portions of the transceiver 30 may be disposed within the processor 12. The transceiver 30 may support transmission and receipt of various wireless signals via one or more antennas, and thus may include a transmitter and a receiver. The power source 29 of the electronic device 10 may include any suitable source of power, such as a rechargeable lithium polymer (Li-poly) battery and/or an alternating current (AC) power converter.

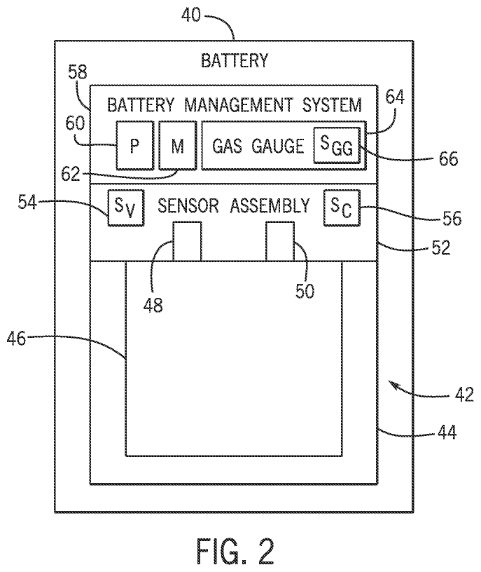

FIG. 2 is a block diagram of an embodiment of a battery employed in the electronic device of FIG. 1. In the illustrated embodiment, the battery 40 includes at least one battery cell 42 formed, for example, by a housing 44, battery cell componentry 46 disposed inside the housing 44 (e.g., electrodes, a separator, and electrolyte), a first terminal 48 (e.g., positive terminal) protruding from the housing 44, and a second terminal 50 (e.g., negative terminal) protruding from the housing 44. The battery 40 also includes a sensor assembly 52 including various sensors, such as a voltage (e.g., operating voltage) sensor 54 configured to detect a voltage (or parameter indicative thereof) and a current (e.g., operating current) sensor 56 configured to detect a current (or parameter indicative thereof). In some embodiments, the voltage (e.g., operating voltage) and/or the current (e.g., operating current) may be determined without the use of the sensors 54, 56. For example, the voltage (e.g., operating voltage) and/or the current (e.g., operating current) may be determined based on various other operating conditions or parameters of the battery 40.

The battery 40 in the illustrated embodiment also includes a battery management system 58. The battery management system 58 may be communicatively coupled with the sensor assembly 52 (e.g., including the voltage sensor 54 and the current sensor 56) such that the battery management system 58 receives sensor feedback from the sensor assembly 52. Further, the battery management system 58 may include processing circuitry 60, memory circuitry 62, and a gas gauge 64. While the gas gauge 64 is illustrated as a part of the battery management system 58 in the illustrated embodiment, the gas gauge 64 may be separate from (and communicatively coupled with) the battery management system 58 in other embodiments.

In general, the gas gauge 64 may be employed to monitor a state of charge (SOC) of the battery 40, among other possible operating conditions of the battery 40. Further, the gas gauge 64 may include a gas gauge sensor 66 configured to detect, for example, a gas gauge temperature. Additionally or alternatively, the gas gauge sensor 66 (or multiple such sensors) may detect one or more battery parameters that can be used to determine the gas gauge temperature (e.g., current, resistance, voltage, impedance, etc.). Additionally or alternatively, the SOC of the battery 40, determined by the gas gauge 64 and/or the gas gauge sensor 66, may be employed to determine the gas gauge temperature. The parameters monitored by the gas gauge 64 (e.g., gas gauge temperature, SOC) may generally be employed to monitor a battery health of the battery 40. In accordance with the present disclosure, the gas gauge temperature may also be employed to determine an estimated temperature of the battery cell 42 of the battery 40, as described in detail below.

The memory circuitry 62 of the battery management system 58 includes instructions stored thereon that, when executed by the processing circuitry 60 of the battery management system 58, causes the processing circuitry 60 to perform various functions. For example, in accordance with the present disclosure and as described in detail below, the processing circuitry 60 may determine an estimated temperature of the battery cell 42 based at least in part on the gas gauge temperature and other conditions (e.g., the battery voltage detected by the voltage sensor 54 of the sensor assembly 52, the battery current detected by the current sensor 56 of the sensor assembly 52, and/or other possible operating conditions of the battery 40).

In accordance with an embodiment of the present disclosure, the battery management system 58 may determine an estimated temperature of the battery cell 42 based on the gas gauge temperature (e.g., detected by the gas gauge sensor 66), the battery voltage (e.g., detected by the voltage sensor 54, the battery current (e.g., detected by the current sensor 56), a voltage corresponding to a battery open-circuit voltage (OCV) model, a number of models relating to heat generation and heat transfer aspects of the battery 40, and/or coefficients relating to various characteristics of the battery 40. For example, the battery management system 58 may execute three models in parallel and relating to the heat generation and heat transfer aspects of the battery 40. The three models include, for example, a battery cell heat generation model, a gas gauge and system heat generation model, and a battery gas gauge heat transfer model.

The battery cell heat generation model may be employed, for example, to account for a rate of heat generated or consumed inside the battery cell 42 for charging or discharging current. Indeed, the battery cell heat generation model may receive various inputs including the voltage corresponding to the battery OCV model (e.g., a measured voltage when the battery current is off with complete equilibrium conditions in terms of open-circuit), the battery voltage measurement (e.g., detected by the voltage sensor 54), the battery current measurement (e.g., detected by the current sensor 56), a first coefficient of heat generation due to cell impedance, and/or a second coefficient of heat generation due to entropy. In this way, an output of the battery cell heat generation model may be a function of the above-described inputs.

The gas gauge and system heat generation model may be employed, for example, as a lumped parameter non-linear heat resistance thermal model. Indeed, the gas gauge and system heat generation model may receive various inputs including the battery current measurement (e.g., detected by the current sensor 56), a third coefficient (e.g., linear coefficient) of gas gauge and system heat generation due to current, and/or a fourth coefficient (e.g., non-linear coefficient) of gas gauge and system heat generation due to current. In this way, an output of the gas gauge and system heat generation model may be a function of the above-described inputs.

The battery gas gauge heat transfer model may be employed, for example, as a lumped parameter heat capacity-resistance thermal model. Indeed, the battery gas gauge heat transfer model may receive various inputs including the gas gauge temperature measurement (e.g., detected by the gas gauge sensor 66), a fifth coefficient of heat transfer between the battery cell 42 and the gas gauge 64, and/or a sixth coefficient of temperature change due to heat capacity. In this way, an output of the battery gas gauge heat transfer model may be a function of the above-described inputs.

In general, the above-described models are employed to account, for example, for various heat transfer and heat generation discrepancies, deviations, accumulations, dissipations, or any combination thereof involving the battery 40 as a whole, the battery cell 42, and the gas gauge 64. Indeed, the gas gauge 64 may generally include a higher temperature than the battery cell 42. Accordingly, the above-described models may be employed to account for the higher temperature of the gas gauge 64 than the battery cell 42, such that a relatively accurate estimated temperature of the battery cell 42 can be determined based at least in part on the gas gauge temperature (e.g., detected by the gas gauge sensor 66). Each of the above-described models may produce a corresponding output that is subsequently employed as an input to further processing logic described in detail below.

For example, thermal input determination logic may receive the three outputs corresponding to the three above-described models. The thermal input determination logic may include, for example, software instructions stored in the memory circuitry 62 (and executed by the processing circuitry 60) of the battery management system 58, hardware separate from the battery management system 58 (e.g., circuitry), or a combination of the two. The thermal input determination logic may receive various inputs including the output of the battery cell heat generation model, the output of the gas gauge and system heat generation model, the output of the battery gas gauge heat transfer model, the gas gauge temperature measurement (e.g., detected by the gas gauge sensor 66) described above, the second coefficient of heat generation due to entropy described above, and/or the fifth coefficient of heat transfer between the battery cell 42 and the gas gauge 64 described above.

Further, battery temperature update logic may be employed to output the estimated temperature of the battery cell 42. For example, like the thermal input determination logic, the battery temperature update logic may include software instructions stored in the memory circuitry 62 (and executed by the processing circuitry 60) of the battery management system 58, hardware separate from the battery management system 58 (e.g., circuitry), or a combination of the two. The battery temperature update logic may receive various inputs including the output from the thermal input determination logic and/or a previously determined estimated temperature of the battery cell 42. Indeed, the algorithm(s) employed by the battery management system 58 and described above may be executed at various time steps, and the battery temperature update logic may receive, as one of the inputs, the previously determined estimated temperature of the battery cell 42 from an earlier algorithm iteration. These and other features will be described in detail below with reference to later drawings.

It should be noted that the above-described coefficients (e.g., the first coefficient, the second coefficient, the third coefficient, the fourth coefficient, the fifth coefficient, and the sixth coefficient) may include constants, though, in some embodiments, the coefficients may not be constants and instead be determined for or variable between each iteration of determining the estimated temperature of the battery cell 42. For example, as described above, the first coefficient may be dependent at least in part on impedance, the second coefficient may be dependent at least in part on entropy, the third coefficient (e.g., linear coefficient) may be dependent at least in part on current, the fourth coefficient (e.g., non-linear coefficient) may be dependent at least in part on current, the fifth coefficient may be dependent at least in part on heat transfer and/or heat capacity, and the sixth coefficient may be dependent at least in part on heat capacity. In some embodiments, the battery management system 58 may determine the various coefficients based on the above-described variables. Additionally or alternatively, a cross-reference or lookup table of coefficients and the above-described variables may be stored in the memory circuitry 62 and employed by the processing circuitry 60 to select the various coefficients for each iteration of determining the estimated temperature of the battery cell 42. More detailed aspects of the above-described models, equations, calculations, variables, inputs, outputs, etc. will be provided below with reference to later drawings. In general, disclosed systems and methods are employed to enable, relative to traditional embodiments, more accurate determinations of the estimated temperature of the battery cell 42, a reduction in volume of the battery 40, an increase in energy density of the battery 40, a reduced cost of the battery 40, or any combination thereof.

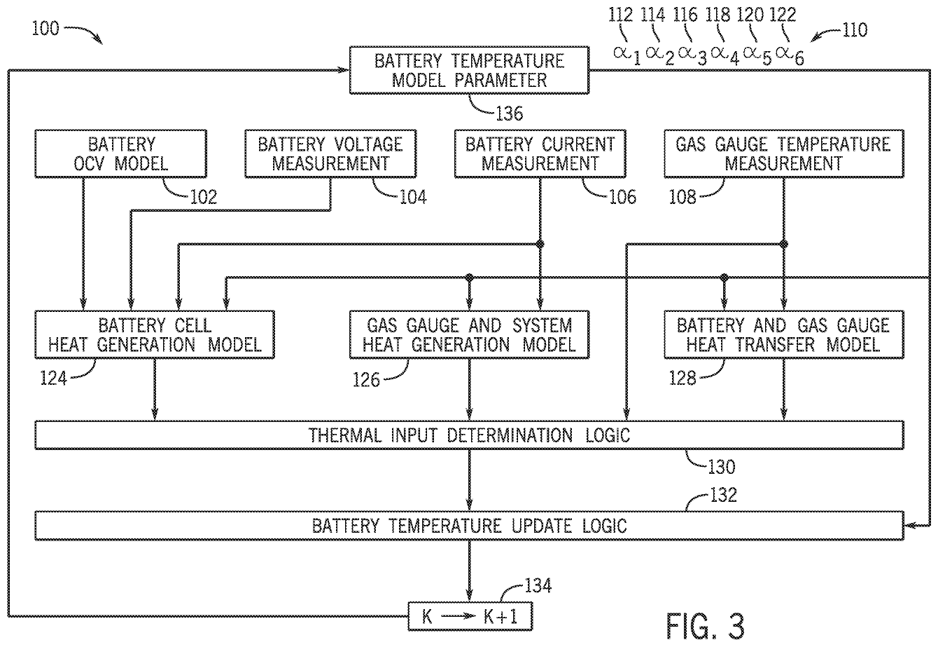

FIG. 3 is a flow diagram illustrating an embodiment of an algorithm 100 for estimating a temperature of a battery cell of the battery of FIG. 2 (e.g., via processing circuitry and/or logic). As shown, the algorithm 100 may rely on various inputs to determine the estimated temperature of the battery cell, including a battery OCV model voltage 102 (e.g., V_{OCV}), a battery voltage measurement 104 at a first time step k (e.g., V[k]), a battery current measurement 106 at the first time step k (e.g., I[k]), a gas gauge temperature measurement 108 at the first time step k (e.g., T_{gg}[k]), and a group of coefficients 110. The group of coefficients 110 includes a first coefficient 112 (α₁), a second coefficient 114 (α₂), a third coefficient 116 (α₃), a fourth coefficient 118 (α₄), a fifth coefficient 120 (α₅), and a sixth coefficient 122 (α₆). As previously described, the first coefficient 112 may be dependent at least in part on impedance, the second coefficient 114 may be dependent at least in part on entropy, the third coefficient 116 (e.g., linear coefficient) may be dependent at least in part on current, the fourth coefficient 118 (e.g., non-linear coefficient) may be dependent at least in part on current, the fifth coefficient 120 may be dependent at least in part on heat transfer and/or heat capacity, and the sixth coefficient 122 may be dependent at least in part on heat capacity.

The algorithm 100 may include, as shown, three models that are executed, for example, in parallel. The first model, referred to as a battery cell heat generation model 124, may produce a first output (e.g., z₁[k]) as illustrated below:

z₁[k]=f₁(α₁,α₂,V_{OCV},V[k],I[k]) Equation 1:

The second model, referred to as a gas gauge and system heat generation model 126, may produce a second output (e.g., z₂[k]) as illustrated below:

z₂[k]=f₂(α₃,α₄,I[k]) Equation 2:

The third model, referred to as a battery and gas gauge heat transfer model 128, may produce a third output (e.g., z₃[k]) as illustrated below:

z₃[k]=f₃(α₅,α₆,V_{ocv},T_{gg}[k]) Equation 3:

The algorithm 100 may also employ (or be executed by or on) thermal input determination logic 130, which may receive the first output of the battery cell heat generation model 124, the second output of the gas gauge and system heat generation model 126, and the third output of the battery and gas gauge heat transfer model 128 (e.g., in addition to other variables). The thermal input determination logic 130, for example, may produce an output (e.g., u[k]) as illustrated below:

u[k]=g(T_{gg}[k],z₁[k],z₂[k],z₃[k],α₂,α₅) Equation 4:

The algorithm 100 may also employ (or be executed by or on) battery temperature update logic 132, which may receive the output of the thermal input determination logic 130 (e.g., in addition to at least one other variable). Further, the battery temperature update logic 132 determines the estimated temperature of the battery cell (e.g., T_{C}[k]). The battery temperature update logic 132, for example, may determine the estimated temperature of the battery cell (e.g., T_{C}[k]) as illustrated below:

T_{c}[k]=h(T_{c}[k−1],u[k]) Equation 5—

After determining the estimated temperature of the battery cell (e.g., T_{C}[k]) via the battery temperature update logic 132, the algorithm 100 progresses to the next time step at block 134 (e.g., k=k+1). Each time step may be, for example, separated by approximately 1 second. Thus, the algorithm 100 may be executed each second. In another embodiment, the time step may include any suitable time period, such as less than 1 second, 2 seconds, 3 seconds, 5 seconds, 10 seconds, or 1 minute or more. Further, the algorithm 100 progresses from block 134 to block 136, at which the first coefficient 112, the second coefficient 114, the third coefficient 116, the fourth coefficient 118, the fifth coefficient 120, and the sixth coefficient 122 are selected and/or determined from the next iteration of the algorithm 100. Detailed description of the selection and/or determination of the six coefficients 112, 114, 116, 118, 120, 122 are provided above with respect to FIG. 2.

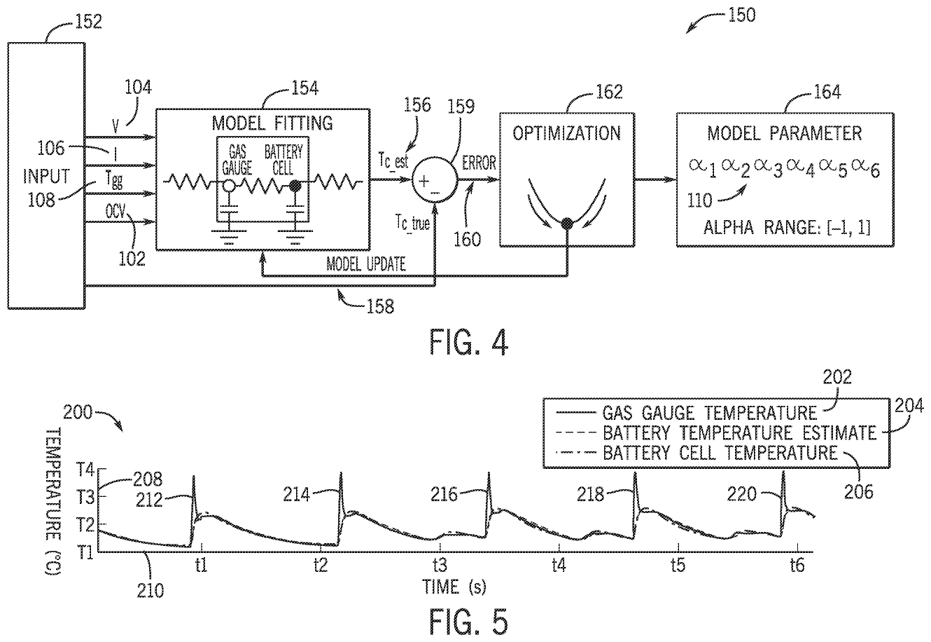

FIG. 4 is schematic illustration of an embodiment of a process 150 for developing the algorithm of FIG. 3. In the illustrated embodiment, the process 150 includes measuring or determining various inputs 152, including the battery OCV model voltage 102, the voltage 104 (e.g., operating voltage), the current 106 (e.g., operating current), and the gas gauge temperature 108, as previously described. The process 150 also includes inputting the various inputs 142 to various models and/or logic 154 (referred to as “models 154” below for brevity).

The various models 154 may include, with reference to FIG. 3, the battery cell heat generation model 124, the gas gauge and system heat generation model 126, the battery and gas gauge heat transfer model 128, the thermal input determination logic 130, and/or the battery temperature update logic 132, which are employed to determine or output an estimated battery cell temperature 156. The process 152 also includes comparing the estimated battery cell temperature 156 with a detected (or true) battery cell temperature 158 (e.g., included as one of the inputs 152). Indeed, the process 150 illustrated in FIG. 4 may be conducted in a laboratory or testing environment in which the battery cell temperature is detected for purposes of model fitting.

A comparator 159 may be employed in the process 150 for comparing the estimated battery cell temperature 156 with the detected battery cell temperature 158. Based on said comparison, the comparator 159 may output an error value 160 to an optimization processor 162. The optimization processor 162 may search for a more optimal or an optimal point of model parameters 164 (e.g. the group of coefficients 110 described with respect to FIG. 3) to decrease or minimize a squared error loss between the estimated battery cell temperature 156 and the detected battery cell temperature 158. The models may be updated (e.g., the newly determined group of coefficients 110 is applied in the models and/or logic 154) until the optimal point settles and the estimated battery cell temperature 156 aligns with the detected battery cell temperature 158 (e.g., within a certain threshold amount) with a sufficiently small error margin. In an embodiment, each model parameter in the model parameters 164 (e.g., each coefficient in the group of coefficients 110) may be within a range of approximately −1 and 1.

FIGS. 5-7 illustrate various results of estimating battery cell temperature based on, for example, gas gauge temperature and other variables, over time, in accordance with the description above with respect to FIG. 1-4. For example, FIG. 5 is an embodiment of a graph 200 illustrating a gas gauge temperature 202, an estimated battery cell temperature 204 (e.g., determined via the algorithm of FIG. 3), and an actual battery cell temperature 206 over a period of time. The actual battery cell temperature 206 illustrated in FIG. 5 may be determined, for example, in a laboratory or testing environment intended to monitor a performance of the estimated battery cell temperature 204 based on presently disclosed systems, methods, and techniques.

The graph 200 in FIG. 5 includes a Y-axis 208 corresponding to temperature (e.g., in Celsius) and an X-axis 210 corresponding to time (e.g., in seconds). In particular, the graph 200 illustrates results of determining the estimated temperature of the battery cell via, for example, the algorithm illustrated in FIG. 3 and the battery (and corresponding componentry) illustrated in FIG. 2. As can be seen in FIG. 5, the estimated battery cell temperature 204 is closely aligned with the actual battery cell temperature 206 despite certain fluctuations 212, 214, 216, 218, 220 in the gas gauge temperature 202. The fluctuations 212, 214, 216, 218, 220 in the gas gauge temperature 202 may be caused, for example, by gas gauge power spikes (illustrated in FIG. 7) and/or user activity on the electric device being powered by the presently disclosed battery. Presently disclosed systems and methods are employed to accurately determine the estimated temperature of the battery cell despite the fluctuations 212, 214, 216, 218 in the determined gas gauge temperature 202 illustrated in FIG. 5.

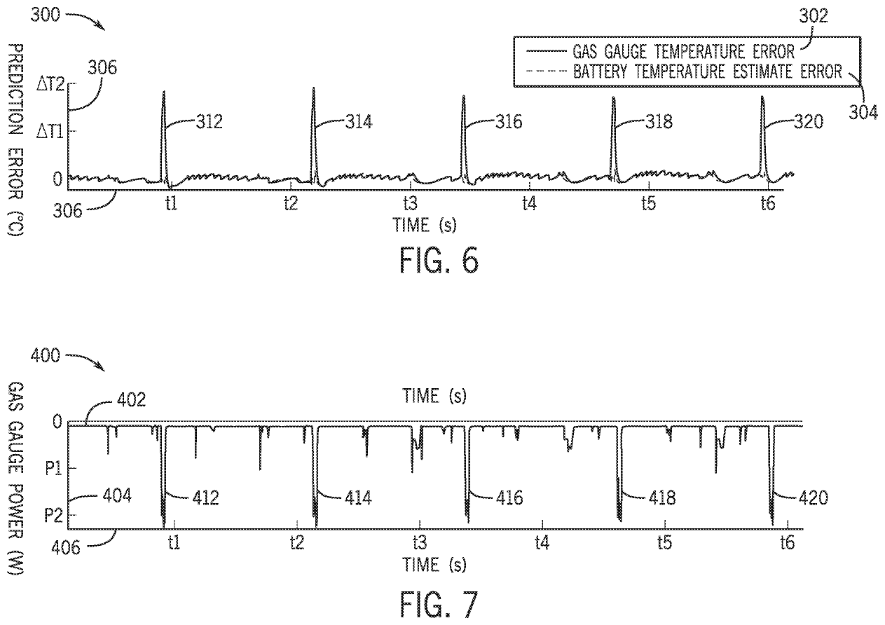

FIG. 6 is an embodiment of a graph 300 illustrating a gas gauge temperature error 302 and an estimated battery cell temperature error 304 over time. The graph 300 includes a Y-axis 306 corresponding to temperature prediction error or delta (e.g., in Celsius) and an X-axis 308 corresponding to time (e.g., in seconds). As can be seen in FIG. 6, the gas gauge temperature error 302 includes certain fluctuations 312, 314, 316, 318, 320 corresponding to the fluctuations 212, 214, 216, 218, 220 illustrated in FIG. 5 and described above. As described with respect to the fluctuations 212, 214, 216, 218, 220 in FIG. 5, the fluctuations 312, 314, 316, 318, 320 in FIG. 6 may be caused, for example, by gas gauge power spikes (illustrated in FIG. 7) and/or user activity on the electric device being powered by the presently disclosed battery.

FIG. 7 is an embodiment of a graph 400 illustrating a gas gauge power 402 over time. The graph 400 includes a Y-axis 404 corresponding to power (e.g., in Watts) and an X-axis 406 corresponding to time (e.g., in seconds). As shown in FIG. 7, power spikes 412, 414, 416, 418, 420 in the gas gauge power 402 may occur at various moments in time along the X-axis 406. The power spikes 412, 414, 416, 418, 420 may occur due to user activity on the electric device being powered by the presently disclosed battery. That is, user activity on the electric device may cause spikes in various conditions (or measurements/determinations of conditions) at the gas gauge. Because said spikes relating to the gas gauge are not necessarily indicative or reflective of the battery cell temperature, presently disclosed systems, methods, and techniques may be employed to accurately determine the estimated temperature of the battery cell despite said spikes relating to the gas gauge. Indeed, while certain conditions may cause a rise in gas gauge temperature, for example, said conditions do not necessarily cause a rise in battery cell temperature. Accordingly, presently disclosed techniques may be employed to ensure that the determination of the estimated temperature of the battery cell is not influenced by spikes in conditions associated with the gas gauge.

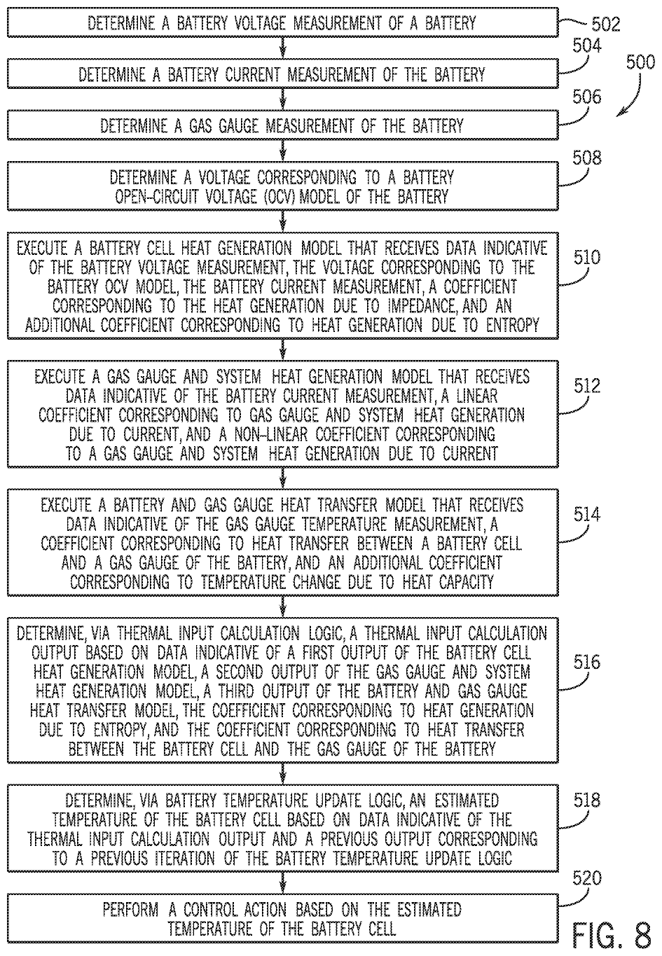

FIG. 8 is a process flow diagram illustrating an embodiment of a method 500 of estimating a battery cell temperature based on various inputs and various models. In general, the method 500 may be employed to determine an estimated temperature of a battery cell of a battery based on various inputs and models. It should be noted that the illustrated ordering of the blocks of the method 500 in FIG. 8 should not be taken to necessarily mean or imply a chronology of the various steps of the method 500.

For example, the method 500 includes determining (block 502) a battery voltage measurement of a battery. As previously described, the battery voltage measurement may be detected via a sensor or determined based on various operating conditions of the battery. Processing circuitry of a battery management system may determine or receive data indicative of the battery voltage measurement. The method 500 also includes determining (block 504) a battery current measurement of the battery. As previously described, the battery current measurement may be detected via a sensor or determined based on various operating conditions of the battery. The processing circuitry of the battery management system may determine or receive data indicative of the battery current measurement. The method 500 also includes determining (block 506) a gas gauge measurement of the battery. As previously described, the gas gauge temperature measurement may be detected via a sensor or determined based on various operating conditions (e.g., state of charge (SOC) of the battery). The processing circuitry of the battery management system may determine or receive data indicative of the gas gauge temperature measurement. The method 500 also includes determining (block 508) a voltage corresponding to a battery open-circuit voltage (OCV) model of the battery. As previously described, the voltage corresponding to the battery OCV model may be a measured voltage when the battery current is off with complete equilibrium conditions in terms of open-circuit.

The method 500 also includes executing (block 510) a battery cell heat generation model via, for example, the processing circuitry of the battery management system. For example, the battery cell heat generation model receives various inputs, including data indicative of the battery voltage measurement, the voltage corresponding to the battery OCV model, the battery current measurement, a coefficient corresponding to heat generation due to impedance, and an additional coefficient corresponding to heat generation due to entropy. Based on the above-described inputs and corresponding data, the battery cell heat generation model may produce a first output.

The method 500 also includes executing (block 512) a gas gauge and system heat generation model via, for example, the processing circuitry of the battery management system. For example, the gas gauge and system heat generation model receives various inputs, including data indicative of the battery current measurement, a linear coefficient corresponding to gas gauge and system heat generation due to current, and a non-linear coefficient corresponding to gas gauge and system heat generation due to current. Based on the above-described inputs and corresponding data, the gas gauge and system heat generation model may produce a second output.

The method also includes executing (block 514) a battery and gas gauge heat transfer model via, for example, the processing circuitry of the battery management system. For example, the battery and gas gauge heat transfer model receives various inputs, including data indicative of the gas gauge temperature measurement, a coefficient corresponding to heat transfer between a battery cell and a gas gauge of the battery, and an additional coefficient corresponding to temperature due to heat capacity.

The method also includes determining (block 516), via thermal input determination logic, a thermal input calculation output based on various inputs. The thermal input determination logic, as previously described, may correspond to software executed by the processing circuitry of the battery management system, or hardware separate from the processing circuitry. In general, the thermal input determination logic may receive various inputs, including data indicative of the first output of the battery cell heat generation model, the second output of the gas gauge and system heat generation model, the third output of the battery and gas gauge heat transfer model, the coefficient corresponding to heat generation due to entropy, and the coefficient corresponding to heat transfer between the battery cell and the gas gauge of the battery. Based on the above-described inputs and corresponding data, the thermal input determination logic may produce a thermal input calculation output.

The method also includes determining (block 518), via battery temperature update logic, the estimated temperature of the battery cell. The battery temperature update logic, as previously described, may correspond to software executed by the processing circuitry of the battery management system, or hardware separate from the processing circuitry. In general, the battery temperature update logic may receive various inputs, including data indicative of the thermal input calculation output and a previous output corresponding to a previous iteration of the battery temperature update logic. Based on the above-described inputs and corresponding data, the battery temperature update logic may determine (or produce) the estimated temperature of the battery cell.

The method also includes performing (block 520) a control action based on the estimated temperature of the battery cell. For example, the control action may be performed or executed by the processing circuitry of the battery management system or other processing circuitry. The control action may include, for example, disconnecting the battery from an electric (e.g., electronic) device associated with the battery in response to the estimated temperature of the battery cell deviating from a target temperature by a threshold amount, exceeding a threshold temperature, or dropping below a threshold temperature. Additionally or alternatively, the control action may include, for example, blocking a charging procedure in response to the estimated temperature of the battery cell deviating from a target temperature by a threshold amount, exceeding a threshold temperature, or dropping below a threshold temperature. Other control actions based on the estimated temperature of the battery cell deviating from a target temperature by a threshold amount, exceeding a threshold temperature, or dropping below a threshold temperature may include, for example, changing a charging aspect of the battery, changing a discharging aspect of the battery, sending an alert to the electric (e.g., electronic) device or some other device, actuating a switch to complete or break or a circuit associated with the battery or the electric (e.g., electronic) device, and the like.

Embodiments of the present disclosure are directed toward determining, via a battery management system of a battery, an estimated temperature of a battery cell of the battery based on various inputs and models described in detail above. Technical effects associated with the embodiments of the present disclosure include, relative to traditional systems and methods, more accurately determining the estimated temperature of the battery cell, reducing a cost of the battery, reducing a volume of the battery, improving an energy density of the battery, or any combination thereof.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S.C. 112(f). However, for any claims containing elements designated in any other manner, it is intended that such elements are not to be interpreted under 35 U.S.C. 112(f).

1. A battery, comprising:
a battery cell; and
processing circuitry configured to determine an estimated temperature of the battery cell as a function of:
a battery cell heat generation model that receives a first input indicative of a battery voltage measurement, a second input indicative of a voltage corresponding to a battery open-circuit voltage (OCV) model, and a third input indicative of a battery current measurement;
a gas gauge and system heat generation model that receives the third input; and
a battery and gas gauge heat transfer model that receives a fourth input indicative of a gas gauge temperature measurement.

2. The battery of claim 1, wherein the processing circuitry is configured to determine the estimated temperature of the battery cell as the function of the battery cell heat generation model that receives the first input, the second input, the third input, a fifth input indicative of a coefficient corresponding to heat generation due to impedance, and a sixth input indicative of an additional coefficient corresponding to heat generation due to entropy.

3. The battery of claim 1, wherein the processing circuitry is configured to determine the estimated temperature of the battery cell as the function of the gas gauge and system heat generation model that receives the third input, a fifth input indicative of a linear coefficient corresponding to gas gauge and system heat generation due to current, and a sixth input indicative of a non-linear coefficient corresponding to gas gauge and system heat generation due to current.

4. The battery of claim 1, wherein the processing circuitry is configured to determine the estimated temperature of the battery cell as the function of the battery and gas gauge heat transfer model that receives the fourth input, a fifth input indicative of a coefficient corresponding to heat transfer between the battery cell and a gas gauge of the battery, and a sixth input indicative of an additional coefficient corresponding to temperature change due to heat capacity.

5. The battery of claim 1, comprising thermal input determination logic that receives a first output of the battery cell heat generation model, a second output of the gas gauge and system heat generation model, a third output of the battery and gas gauge heat transfer model, the fourth input, a fifth input indicative of a coefficient corresponding to heat generation due to entropy, and a sixth input indicative of an additional coefficient corresponding to heat transfer between the battery cell and a gas gauge.

6. The battery of claim 5, comprising battery temperature update logic that:
receives a fourth output of the thermal input determination logic;
receives a previous output of a previous iteration of the battery temperature update logic; and
outputs the estimated temperature of the battery cell based on the fourth output and the previous output.

7. The battery of claim 1, comprising a gas gauge sensor communicatively coupled with the processing circuitry, wherein the gas gauge sensor is configured to detect a parameter indicative of the gas gauge temperature measurement.

8. The battery of claim 1, wherein the processing circuitry is configured to determine the estimated temperature of the battery cell within a temperature range of approximately −20 degrees Celsius and 65 degrees Celsius.

9. The battery cell of claim 1, comprising at least one sensor communicatively coupled with the processing circuitry, wherein the at least one sensor is configured to detect the battery voltage measurement, or the battery current measurement, or both.

10. One or more tangible, non-transitory, computer-readable media storing instructions thereon that, when executed by one or more processors, are configured to cause the one or more processors to:
execute a battery cell heat generation model that receives a first input indicative of a battery voltage measurement of a battery, a second input indicative of a voltage corresponding to a battery open-circuit voltage (OCV) model of the battery, and a third input indicative of a battery current measurement of the battery;
execute a gas gauge and system heat generation model that receives the third input;
execute a battery and gas gauge heat transfer model that receives a fourth input indicative of a gas gauge temperature measurement of the battery; and
determine, based on a first output of the battery cell heat generation model, a second output of the gas gauge and system heat generation model, and a third output of the battery and gas gauge heat transfer model, an estimated temperature of a battery cell of the battery.

11. The one or more tangible, non-transitory, computer-readable media of claim 10, wherein the instructions, when executed by the one or more processors, are configured to cause the one or more processors to execute the battery cell heat generation model that receives the first input, the second input, the third input, a fifth input indicative of a coefficient corresponding to heat generation due to impedance, and a sixth input indicative of an additional coefficient corresponding to heat generation due to entropy.

12. The one or more tangible, non-transitory, computer-readable media of claim 10, wherein the instructions, when executed by the one or more processors, are configured to cause the one or more processors to execute the gas gauge and system heat generation model that receives the third input, a fifth input indicative of a linear coefficient corresponding to gas gauge and system heat generation due to current, and a sixth input indicative of a non-linear coefficient corresponding to gas gauge and system heat generation due to current.

13. The one or more tangible, non-transitory, computer-readable media of claim 10, wherein the instructions, when executed by the one or more processors, are configured to cause the one or more processors to execute the battery and gas gauge heat transfer model that receives the fourth input, a fifth input indicative of a coefficient corresponding to heat transfer between the battery cell and a gas gauge of the battery, and a sixth input indicative of an additional coefficient corresponding to temperature change due to heat capacity.

14. The one or more tangible, non-transitory, computer-readable media of claim 10, comprising thermal input determination logic that receives the first output, the second output, the third output, the fourth input, a fifth input indicative of a coefficient corresponding to heat generation due to entropy, and a sixth input indicative of an additional coefficient corresponding to heat transfer between the battery cell and a gas gauge.

15. The one or more tangible, non-transitory, computer-readable media of claim 14, comprising battery temperature update logic that:
receives a fourth output of the thermal input determination logic;
receives a previous output of a previous iteration of the battery temperature update logic; and
outputs the estimated temperature of the battery cell of the battery based on the fourth output and the previous output.

16. The one or more tangible, non-transitory, computer-readable media of claim 10, wherein the instructions, when executed by the one or more processors, are configured to cause the one or more processors to determine, based on the first output, the second output, and the third output, the estimated temperature of the battery cell of the battery within a temperature range of approximately −20 degrees Celsius and 65 degrees Celsius.

17. A method of determining an estimated temperature of a battery cell of a battery, the method comprising:
determining a battery voltage measurement;
determining a battery current measurement;
determining a gas gauge temperature measurement;
determining a voltage corresponding to a battery open-circuit voltage (OCV) model; and
determining, via processing circuitry, the estimated temperature of the battery cell based on a plurality of models, the battery voltage measurement, the battery current measurement, the gas gauge temperature measurement, and the voltage corresponding to the battery OCV model.

18. The method of claim 17, comprising:
executing, via the processing circuitry, a battery cell heat generation model of the plurality of models such that the battery cell heat generation model receives a first input indicative of the battery voltage measurement, a second input indicative of the voltage corresponding to a battery open-circuit voltage (OCV) model, and a third input indicative of the battery current measurement;
executing, via the processing circuitry, a gas gauge and system heat generation model of the plurality of models such that the gas gauge and system heat generation model receives the third input; and
executing, via the processing circuitry, a battery and gas gauge heat transfer model of the plurality of models such that the battery and gas gauge heat transfer model receives a fourth input indicative of a gas gauge temperature measurement.

19. The method of claim 18, comprising:
executing, via the processing circuitry, the battery cell heat generation model such that the battery cell heat generation model receives the first input, the second input, the third input, a first coefficient corresponding to heat generation due to impedance, and a second coefficient corresponding to heat generation due to entropy;
executing, via the processing circuitry, the gas gauge and system heat generation model such that the gas gauge and system heat generation model receives the third input, a third linear coefficient corresponding to gas gauge and system heat generation due to current, and a fourth non-linear coefficient corresponding to gas gauge and system heat generation due to current; and
executing, via the processing circuitry, the battery and gas gauge heat transfer model such that the battery and gas gauge heat transfer model receives the fourth input, a fifth coefficient corresponding to heat transfer between the battery cell and a gas gauge of the battery, and a sixth coefficient corresponding to temperature change due to heat capacity.

20. The method of claim 18, comprising:
determining, via thermal input determination logic, a thermal input determination output based on a first output of the battery cell heat generation model, a second output of the gas gauge and system heat generation model, a third output of the battery and gas gauge heat transfer model, the fourth input, a coefficient corresponding to heat generation due to entropy, and an additional coefficient corresponding to heat transfer between the battery cell and a gas gauge; and
determining, via battery temperature update logic, the estimated temperature of the battery cell based on the thermal input determination output and a previous output of a previous iteration of the battery temperature update logic.
